(19) United States
(12) Patent Application Publication
(10) Pub. No.: US 2006/0293093 A1
(43) Pub. Date: Dec. 28, 2006

(54) Portable device with text-entry keyboard

(75) Inventor: Sean A. Marcus, Youngsville, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/166,944

(22) Filed: Jun. 24, 2005

(51) Int. Cl. H04M 1/00

(52) U.S. Cl. 455/575.3; 455/575.4

(57) ABSTRACT

A housing for a mobile communication device comprises first, second and third housing sections. The second housing section is slidably connected to the first housing section and rotatably connected to the third housing section. Movement of the first housing section from a closed position to an open position exposes a first protected surface containing a first input device. Movement of the third housing section from a closed position to an open position exposes a second protected surface containing a second input device.

### BACKGROUND OF THE INVENTION

The present invention relates generally to portable communication devices and, more particularly, to keyboard arrangements for portable communication devices.

Portable electronic devices have become a ubiquitous accruement for consumers in modern society. Such devices include mobile phones, personal digital assistants, cameras, and audio players. Because it is inconvenient to carry numerous such devices to perform different functions, consumers desire multi-function devices that can perform a variety of functions. This trend has led to a convergence of wireless communication and computing technologies in a single device. Such devices may also include a camera and audio play recording/playback capabilities.

One challenge to designers for such multi-function devices is providing a convenient means for text entry in a compact space. Many mobile communication devices rely on a standard numeric phone keypad for text entry where a plurality of letters or symbols are assigned to each key. Other devices use a touchscreen with handwriting recognition system for text entry. Text entry with either standard numeric keypads or handwriting recognition systems can be slow and laborious. Further, handwriting recognition systems are highly dependent on the input quality. A standard QWERTY keyboard provides a more convenient means for text entry for most consumers. The challenge is to accommodate a standard QWERTY keyboard into a compact mobile communication device.

### SUMMARY OF THE INVENTION

The present invention provides a portable multi-function device with a plurality of user interface elements that can be selectively exposed depending upon the task to be performed. The portable device comprises three housing sections. A first housing section is slidably mounted to the second housing section, while a third housing section is rotatably connected to the second housing section. Sliding the first housing section from a closed position to an open position exposes a first protected surface containing a first user input device. Rotating the third housing section from a closed position to an open position exposes a second user input device.

In one exemplary embodiment, the first housing section comprises a top section, the second housing section comprises a middle section, and the third housing section comprises a bottom section. The first protected surface is disposed on the second housing section. The first protected surface is covered when the first housing section is in the closed position, and is exposed when the first housing section is in the open position. The second protected surface is disposed on the third housing section. The second protected surface is covered when the third housing section is in the closed position, and is exposed when the third housing section is in the open position. This embodiment may include a display on the first housing section that is visible when the first housing section is in both the open and closed positions.

In another exemplary embodiment, the first housing section comprises a bottom section, the second housing section comprises a middle section, and the third housing section comprises a top section. The first protected surface is disposed on the first housing section. The first protected surface is covered when the first housing section is in the closed position and is exposed when the first housing section is in the open position. The second protected surface is disposed on the second housing section. The second housing section is covered when the third housing section is in the closed position, and is exposed when the third housing section is in the open position. This embodiment may include a display on the third housing section that is visible when the third housing section is in both the open and closed positions.

### BRIEF DESCRIPTION OF THE DRAWINGS

FIG. 1 is a top view of a mobile communication device in a closed position.

FIG. 2 is a top view of the mobile communication device of FIG. 1 with a first keyboard in a deployed position.

FIG. 3 is a top view of the mobile communication device of FIG. 1 with a second keyboard in a deployed position.

FIG. 4 is an exploded section view of the mobile communication device of FIG. 1.

FIG. 5 is a top view of another mobile communication device in a closed position.

FIG. 6 is a top view of the mobile communication device of FIG. 5 with a first keyboard in a deployed position.

FIG. 7 is a top view of the mobile communication device of FIG. 5 with a second keyboard in a deployed position.

FIG. 8 is an exploded section view of the mobile communication device of FIG. 5.

FIG. 9A-9C is a detail section view of a first locking mechanism for preventing deployment of the first keyboard.

FIG. 10 is a detail section view of a second locking mechanism for preventing deployment of the second keyboard.

FIG. 11 is a functional block diagram of the mobile communication device.

### DETAILED DESCRIPTION OF THE INVENTION

Referring now to the drawings, a mobile communication device according to one exemplary embodiment of the present invention is shown therein and indicated generally by the numeral 100. Mobile communication device 100 includes a housing comprised of three housing sections 102, 106, 110.

The first housing section 102, referred to herein as the top section, includes an electronic display 150, a joystick control 146, and a plurality of function keys 148 disposed in a top surface 104 thereof. Display 150 may comprise a conventional liquid crystal display or touchscreen display. Display 150 enables the user to view information, such as status information, menu options, and application data. The joystick control 146 and function keys 148 may be used to control the operation of the mobile communication device 100. Joystick control 146 enables the user to navigate through menus presented on the display 150, move a pointer on the display, and to select menu items and other items presented on the display 150. Function keys 148 may have functions assigned thereto that are activated or enabled by pressing a corresponding function key 148. For example, in a default mode, the function keys 148 may be used to initiate and/or end a call. The particular functions assigned to the function keys 148 may change depending on the operating mode.

Housing section 106, seen in FIG. 2 and referred to herein as the middle section, includes a QWERTY keyboard 142 on the top surface 108. The QWERTY keyboard 142 may be used for text entry and general computing applications as a conventional computer keyboard. The QWERTY keyboard 142 is oriented with the long axis of the mobile communication device 100. When the QWERTY keyboard 142 is deployed as shown in FIG. 2, the CPU 120 of the mobile communication device 100 generates a signal to change the display mode from a normal portrait mode to a landscape mode.

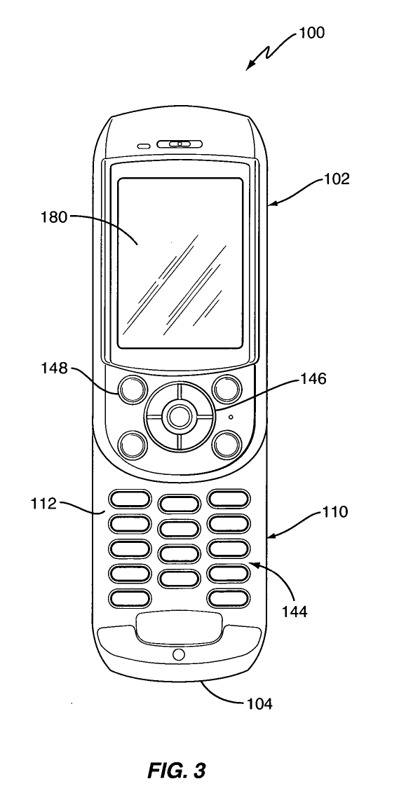

The third housing section 110, seen in FIG. 3 and referred to herein as the bottom section, includes a standard phone keypad 144 on the top surface 112. Phone keypad 144 is used to perform standard phone operations, such as dialing, answering calls and terminating calls. When the phone keypad 144 is in the deployed position as shown in FIG. 3, the CPU 120 generates a control signal to set the display mode of the display 150 to the normal portrait mode.

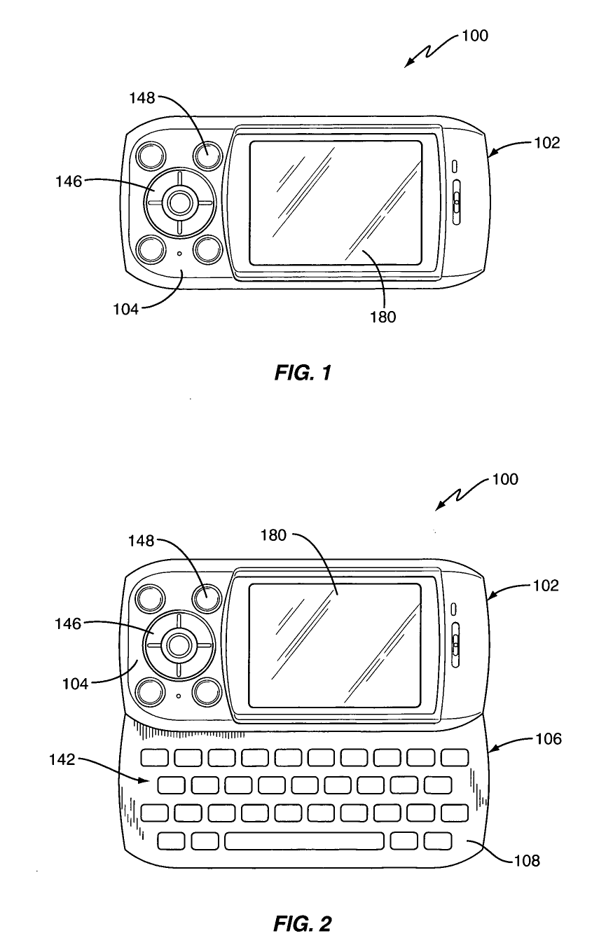

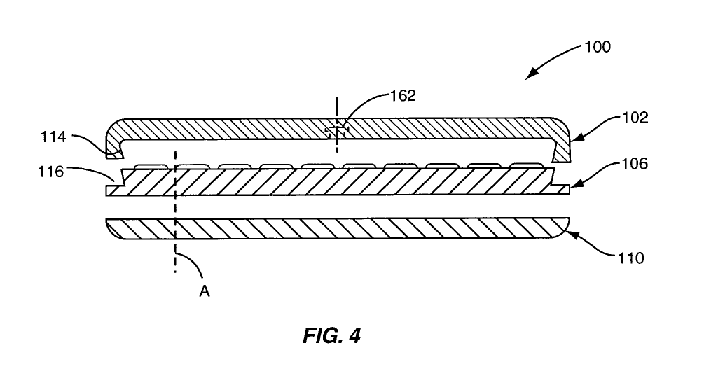

The top section 102 of the housing is slidably connected to the middle section 106 so that top section 102 slides upwardly from a closed position as shown in FIG. 1 to an open position as shown in FIG. 2. Top section 102 includes a downwardly-projecting sidewall or lip 114 as seen in FIG. 4 that engages tracks 116 formed on the middle section 106. The sidewalls 114 and tracks 116 are configured to retain the top section 102 on the middle section 106 while allowing the top section 102 to slide relative to the middle section 106. The top section 102 slides between a closed position shown in FIG. 1 and an open position shown in FIG. 2. In the closed position, the top surface 108 of the middle section 106 is covered. When moved to the open position, the top surface 108 of the middle section 106 is exposed providing access to the QWERTY keyboard 142. In the disclosed embodiment, top section 102 and middle section 106 are congruent in size and shape. Thus, in the closed position, the entire top surface 108 of the middle section 106 is covered. In other embodiments, top section 102 may be smaller than middle section 106 so that at least a portion of the top surface 108 of middle section 106 remains exposed even when the top section 102 is in the closed position. In such embodiments, a portion of keyboard 142 may be exposed. As one example, the bottom row of keys on keyboard 142 may be visible when the top section 102 is in the closed position. The display 150 is visible when the first housing section is in both the open and closed positions.

The middle section 106 is rotatably connected to the bottom section 110 such that the bottom section 110 rotates about an axis A between a closed position (shown in FIG. 1) and an open position (shown in FIG. 3). In the closed position, the middle section 106 covers at least a portion of the top surface 112 of the bottom section 110. In the open position, at least a portion of the top surface 112 is exposed to provide access with the phone keypad 144. In the disclosed embodiment, the middle section 106 is congruent in size and shape with the bottom section 110 so that the entire top surface 112 is covered when the bottom section 110 is in the closed position. In other embodiments, the middle section 106 may be smaller than the bottom section 110 so that a portion of the top surface 112 remains exposed when the bottom section 110 is moved to the closed position. For example, the bottom row of keys on the keypad 144 may remain exposed and accessible when the bottom section 110 is moved to the closed position.

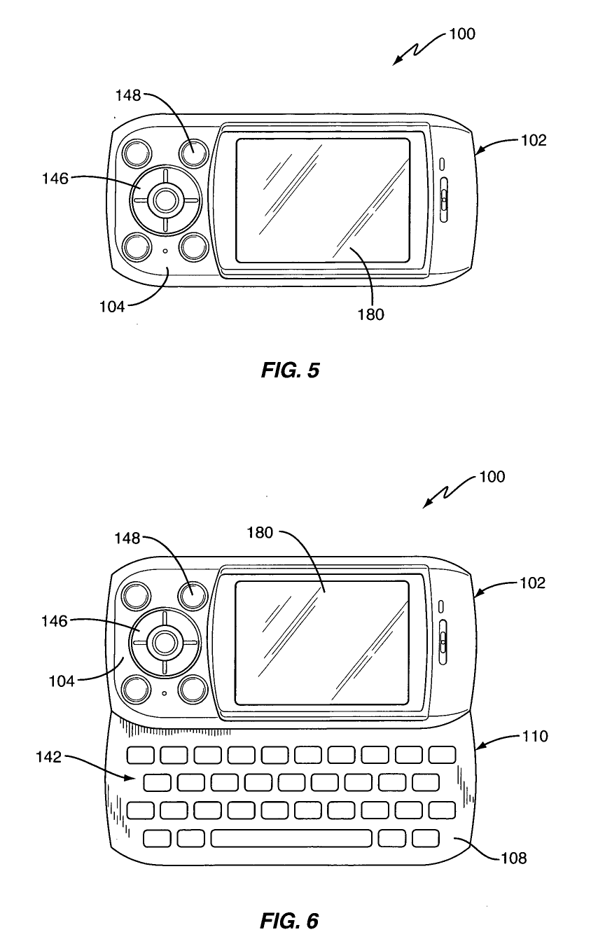

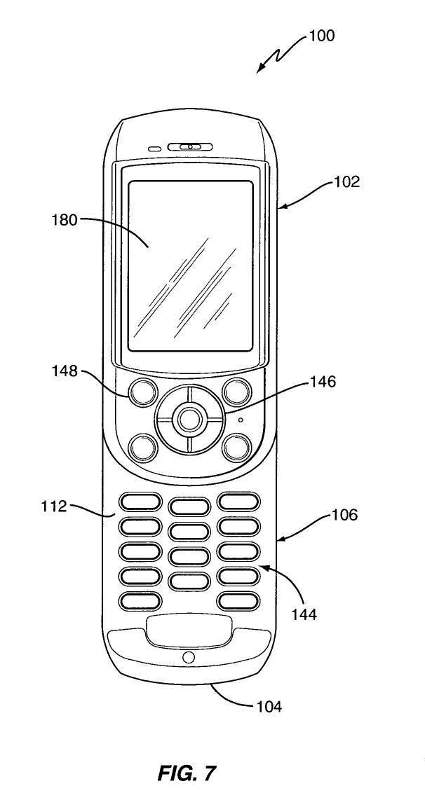

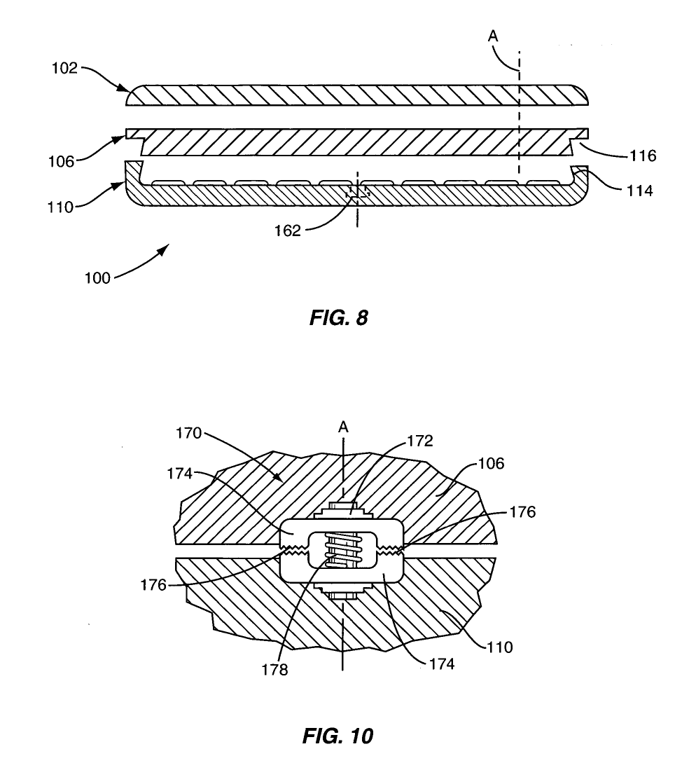

FIGS. 5-8 illustrate an alternate mobile communication device 100 according to the present invention. In this embodiment, top section 102 pivots relative to middle section 106, while bottom section 110 slides relative to middle section 106. Accordingly, QWERTY keyboard 142 is disposed on bottom section 110, while phone keypad 144 is disposed on middle section 106. All other aspects of the invention remain as described above.

In some embodiments, a first locking mechanism 150 may be provided to prevent the top section 102 from inadvertently sliding when pivoting the bottom section 110 relative to the middle section 106 in the embodiment shown in FIGS. 1-4. Similarly, a second locking mechanism 170 may be provided to prevent rotation of the bottom section 110 relative to the middle section 106 when sliding the top section 102 from the closed position to the open position. It will be appreciated that first locking mechanism 150 may also be provided to prevent the bottom section 110 from inadvertently sliding when pivoting the top section 102 relative to the middle section in the embodiment shown in FIGS. 5-8, while the second locking mechanism 170 may be provided to prevent rotation of the top section 102 relative to the middle section 106 when sliding the bottom section 110 from the closed position to the open position.

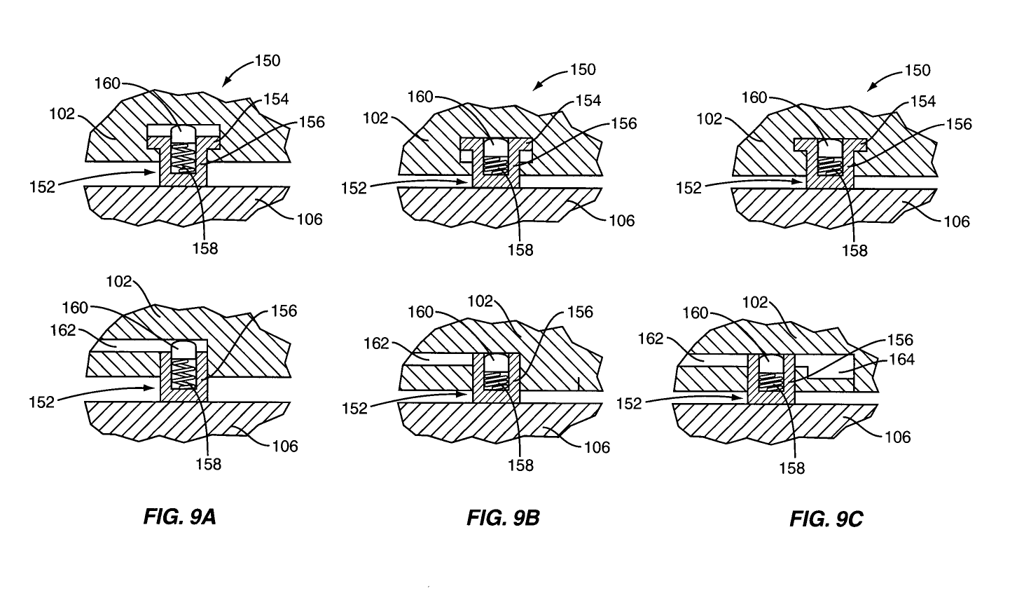

FIGS. 9A-9C illustrate an exemplary embodiment of the first locking mechanism 150. FIGS. 9A-9C illustrate the locking mechanism in three different positions. The view on top in each Figure is a cross-section of the locking mechanism 150. The view on bottom is a longitudinal section view of the locking mechanism 150.

Locking mechanism 150 comprises a locking member 152 that is fixedly-secured to the middle section 106. Locking member 152 includes lateral projections 154 and an axial bore 156. Locking member 152 engages a T-shaped channel 162 in the bottom surface of the top section 102. The end of the T-shaped channel 162 includes a notch 164. A compression spring 158 and slide bearing 160 are disposed in the axial bore 156 of the locking member 152. Spring 158 urges the bearing member 160 against the top of the T-shaped channel 162. FIG. 9A illustrates the locking mechanism 150 when the top section 102 is in the closed position. In this position, the spring 158 exerts an upward force on the top section 102 to seat the lateral projections 154 in the notch 164 of guide channel 162, preventing the top section 102 from sliding relative to the middle section 106. To unlock the top section 102, the user applies downward and lateral force to the top section 102. Pressing the top section 102 downward frees the lateral projections 154 of the locking member 152 from the notch 164 in the guide channel 162 as shown in FIG. 9B. The lateral force causes the top section 102 to slide relative to the middle section 106 as shown in FIG. 9C. When the top section 102 is moved back to the closed position, spring 156 pushes the top section upward to once again seat the lateral projections 154 of the locking member 152 in the end notch 164 of the guide channel 162 as shown in FIG. 5, Section A.

FIG. 10 illustrates the second locking mechanism 170 for preventing rotation of the bottom section 110 relative to the middle section 106. The locking mechanism 170 includes a pair of disk-shaped locking members 174 that rotate about a pivot member 172. Pivot member 172 defines the axis of rotation A. The locking members 174 include serrated surfaces 176. A spring 178 disposed around the pivot member 172 biases the locking members 174 apart as seen in FIG. 6. As long at the locking members 174 are biased apart, the middle section 106 is free to rotate relative to the bottom section 110. Downward pressure applied to middle section 106 and/or upward pressure applied to bottom section 110 moves the locking members 174 into engagement with one another, thereby preventing rotation of sections 106 and 110.

Those skilled in the art will appreciate that when downward pressure is applied to the top section 102, the force will be transmitted through spring 156 to the middle section 106 if the spring constant for spring 158 in the first locking mechanism 150 is greater than the spring constant for spring 178 in the second locking mechanism 170. By careful selection of the spring constants, it can be assured that the second locking mechanism 170 will engage before the first locking mechanism 150 disengages. Thus, once sufficient force is applied to disengage the first locking mechanism 150, rotation of the bottom section 110 relative to the middle section 106 will be prevented.

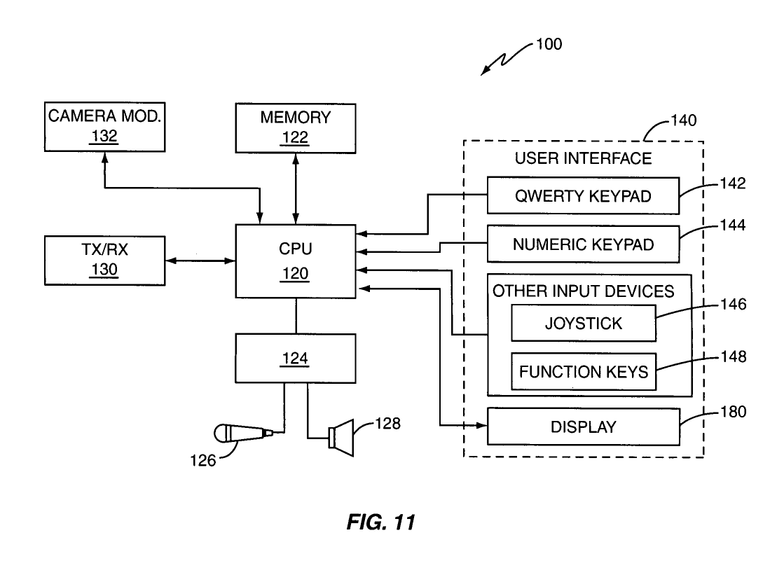

FIG. 11 illustrates the functional elements of the mobile communication device 100. The functional elements include a central processing unit 120, memory 122, audio processing circuit 124, transceiver 130, camera module 132, and user interface 140. The central processing unit 120 controls the overall operation of the mobile communication device 100 according to program instructions stored in memory 122. Memory 122 stores program instructions and data needed for operation. Audio processing circuit 124 processes audio signals input via microphone 126 and output via speaker 128. Microphone 126 converts acoustic signals to electrical audio signals. Speaker 128 converts electrical audio signals into acoustic signals. Transceiver 130 enables communication with remote devices. Transceiver 130 may, for example, comprise a standard cellular transceiver, or short-range wireless interface, such as a Bluetooth transceiver. Camera module 132 is used to capture still and/or video images, which may be stored in memory 122 or sent to a remote party via transceiver 130. User interface 140 operates as an interface between the user and the CPU 120, as discussed above.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

1. A portable device comprising:
a first housing section;
a second housing section slidably connected to the first housing section such that the first housing section slides relative to said second housing section between a closed position and an open position, wherein movement of the first housing section from the closed position to the open position exposes a first protected surface that is at least partially covered when the first housing section is in the closed position; and
a third housing section pivotally connected to the second housing section such that the third housing section rotates between a closed position and open position, wherein movement of the third housing section from the closed position to the open position exposes a second protected surface that is at least partially covered when the third housing section is in the closed position.

2. The portable device of claim 1 wherein the second housing section includes said first protected surface.

3. The portable device of claim 2 wherein the second housing section includes a first input device disposed on the first protected surface that is at least partially covered when the first housing section is in the closed position, and that is exposed when the first housing section is in the open position.

4. The portable device of claim 3 wherein the third housing section includes said second protected surface.

5. The portable device of claim 4 wherein the third housing section includes a second input device disposed on the second protected surface that is at least partially covered when the third housing section is in the closed position, and which is exposed when the third housing section is moved to the open position.

6. The portable device of claim 1 further comprising a display on an outer surface of said first housing section.

7. The portable device of claim 1 wherein the first housing section includes said first protected surface.

8. The portable device of claim 7 further comprising a first input device on said first protected surface that is at least partially covered when said first housing section is in the closed position, and which is exposed when the first housing sections are moved to the open position.

9. The portable device of claim 8 wherein the second housing section includes said second protected surface.

10. The portable device of claim 9 further comprising a second input device on said second protected surface that is at least partially covered when the third housing section is in the closed position, and which is exposed when the third housing section is moved to the open position.

11. The portable device of 10 further comprising a display on an outer surface of said third housing section.

12. The portable device of claim 1 further comprising a first locking mechanism for preventing sliding movement of the first housing section.

13. The portable device of claim 1 further comprising a second locking mechanism for preventing rotation of the third housing section when the first locking mechanism is disengaged.

14. A method of provided a user interface for a portable device, said method comprising:
positioning a first input device on a first protected surface;
exposing the first input device by sliding a first housing section relative to a second housing section from a closed position to an open position;
positioning a second input device on a second protected surface; and
exposing the second input device by rotating a third housing section relative to the second housing section from a closed position to an open position.

15. The method of claim 14 wherein the first protected surface is disposed on the second housing section.

16. The method of claim 15 wherein a portion of the first input device is exposed when the first housing section is in the closed position.

17. The method of claim 15 wherein the second protected surface is disposed on the third housing section includes said second protected surface.

18. The method of claim 17 wherein a portion of the second input device is exposed when the third housing section is in the closed position.

19. The method of claim 17 further comprising a display on an outer surface of said first housing section.

20. The method of claim 14 wherein the first protected surface is disposed on the first housing section.

21. The method of claim 20 wherein a portion of the first input device is exposed when the first housing section is in the closed position.

22. The method of claim 20 wherein second protected surface is disposed on the second housing section.

23. The method of claim 22 wherein a portion of the second input device is exposed when the third housing section is in the closed position.

24. The method of claim 22 further comprising positioning a display on an outer surface of said third housing section.

25. The method of claim 14 further comprising locking the first housing section to prevent sliding movement of the first housing section when the third housing section is rotated.

26. The method of claim 25 further comprising locking the third housing section to prevent rotation of the third housing section when the first housing section is slid.
